(19) United States
(12) Patent Application Publication
(10) Pub. No.: US 2006/0125288 A1
(43) Pub. Date: Jun. 15, 2006

(54) Protection hood for automobile radiators

(76) Inventor: Chiang Lung Cheng, Yung Kang City (TW)

Correspondence Address: LEONG C LEI, PMB # 1008, 1867 YGNACIO VALLEY ROAD, WALNUT CREEK, CA, 94598, US

(21) Appl. No.: 10/777,111

(22) Filed: Feb. 13, 2004

(30) Foreign Application Priority Data
Dec. 30, 2003 (TW) 092222907

(51) Int. Cl. B60J 7/00

(52) U.S. Cl. 296/193.1

(57) ABSTRACT

A protection hood for automobile radiator is disclosed. The protection hood structure comprises a plurality of supporting protection ribs, characterized in that the two ends of the hollow protection rib are mounted with plastic pad, and the appropriate positions on the protection ribs are welded with vertical supporting protection ribs, thereby improving the elasticity and reducing the material cost.

### BACKGROUND OF THE INVENTION

(a) Technical Field of the Invention

The present invention relates to a protection hood, and in particular, to a protection hood for automobile radiators. The protection hood comprises a plurality of hollow tubular rods made from aluminum material so that the radiator is well protected.

(b) Brief Description of The Prior Art

FIG. 1 is a conventional protection hood 1 for radiators and it is made from metallic material. The protection hood 1 comprises metallic protection straps 11 and the appropriate positions of the individual straps 11 have to be made into recess 110 to allow the welding of corresponding vertical metallic protection straps 11. Further the appropriate positions of the vertical metallic protection straps 11 are then soldered with screwing element 12 so that the protection hood can be mounted at the outer side of the radiator to protect the radiator. However, the conventional protection hood has the following drawbacks:

The structure of the conventional protection hood is made of solid material. Therefore, the cost of material is higher.

The method of welding the metallic protection hood strap to the recess is rather troublesome. Since another fabrication procedure is needed, it is not economical to manufacture such a conventional protection hood. The solid and rigid metallic straps are fragile to external force. Thus, it does not achieve the object of protecting the radiator.

In view of the above, it is an object of the present invention to provide a protection hood for automobile radiators which can obviate and mitigate the above drawbacks.

### SUMMARY OF THE INVENTION

Accordingly, it is an object of the present invention is to provide a protection hood structure for radiators of automobile comprising a plurality of hollow protection ribs, characterized in that the two ends of the hollow protection rib are mounted with plastic pad, and the appropriate positions on the protection ribs are welded with vertical supporting protection ribs.

Still another object of the present invention is to provide a protection hood for automobile radiators, wherein the interior center of the hollow protection rib material is hollow thereby minimizing the material in the course of fabrication. Consequently, the cost of production is greatly reduced.

Still a further object of the present invention is to provide a protection hood for automobile radiators, wherein the hollow structure of the protection rib material provides the entire protection hood better elasticity to absorb some external force. The elasticity of the protection ribs enhances better protection of the radiator.

Yet another object of the present invention is to provide a protection hood for automobile radiators, wherein a plurality of horizontal rods welded with vertical supporting protection ribs and screwing element reduces one fabrication step forming recesses as that in the conventional protection hood.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional protection hood for radiators.

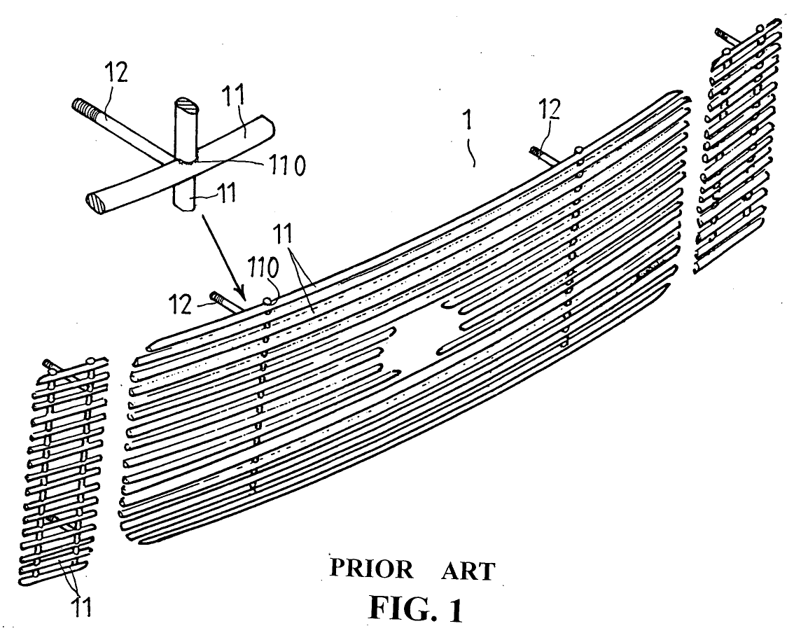

FIG. 2 is a perspective view of a protection hood of radiators in accordance with the present invention.

FIG. 3 is a sectional view of the protection hood for radiators in accordance with the present invention. FIG. 4 is a partial enlarged view of the protection hood for radiators of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

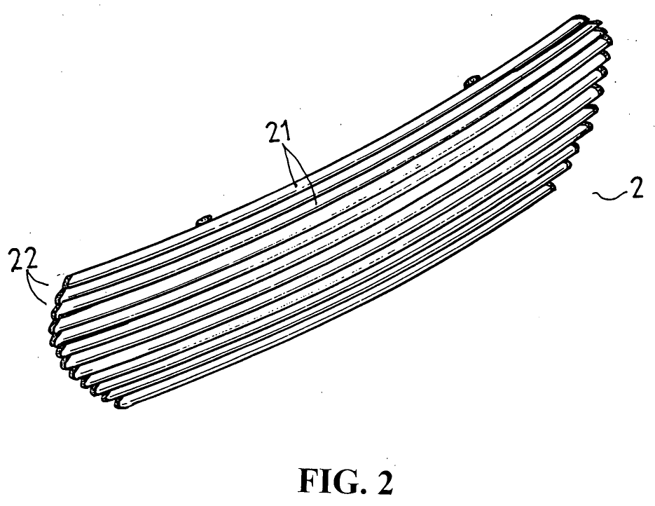

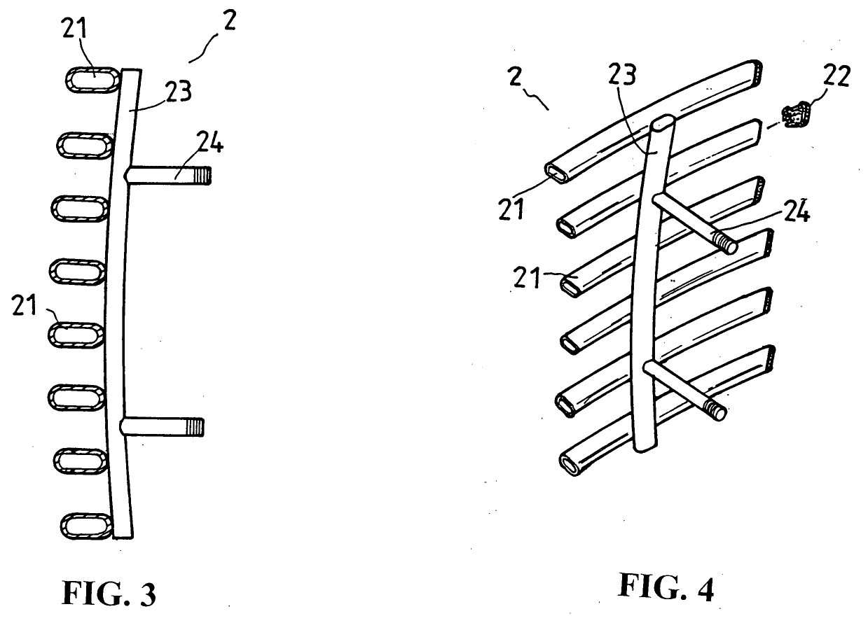

Referring to FIGS. 2 to 4, there is shown respectively a perspective view, a sectional view and an enlarged view of the protection hood for radiators of automobile in accordance with the present invention. The protection hood 2 comprises a plurality of hollow protection ribs 21 which can be made of different sizes to conform with the size of the radiator for different car size. The two ends of the hollow rib 21 are mounted with plastic pad 22 for protection, and the appropriate positions of the hollow protection ribs 21 are welded with vertical supporting protection ribs 23. The appropriate positions of the vertical protection ribs 23 are welded with screwing elements 24 for mounting the protection ribs onto the body of the automobile.

In accordance with the present invention, in application, the protection hood is locked to the car body. The interior center of the hollow protection rib 21 is hollow so that the structure provides a stronger elasticity and therefore it provides a buffering space to absorb external force. At the same, it can counter act with a reaction. Thus, the hollow structure improves the elasticity of the protection ribs and enhances the effectiveness of protection of the radiator. In accordance with the present invention, the material used in minimized and the cost of production is greatly reduced.

Accordingly, the present invention has the following advantages:

1. The interior center of the hollow protection rib is hollow thereby reducing the material required for manufacturing the rib and therefore lowering the material cost.

2. The hollow structure of the protection ribs can improve the elasticity hence providing a buffering space to absorb external force.

3. The two ends of the hollow protection ribs are mounted with plastic pad, and the appropriate positions on the protection ribs are welded with vertical supporting protection ribs, thus eliminating the procedure for forming a recess as is required by the conventional method and therefore simplifying the manufacturing process.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A protection hood structure for radiators of automobile comprising a plurality of hollow protection ribs, characterized in that the two ends of the hollow protection rib are mounted with plastic pad, and the appropriate positions on the protection ribs are welded with vertical supporting protection ribs.

2. The protection hood structure of claim 1, wherein the vertical protection rib is provided with screwing elements so that the protection hood is installed onto the body of the automobile.
